(19) United States
(12) Patent Application Publication
(10) Pub. No.: US 2010/0075006 A1
(43) Pub. Date: Mar. 25, 2010

(54) Antimicrobial Process Using Peracetic Acid During Whey Processing

(75) Inventor: Reed Semenza, Galt, CA (US)

Correspondence Address: LATHROP & GAGE LLP, 2345 GRAND Boulevard, SUITE 2400, KANSAS CITY, MO, 64108, US

(73) Assignee: DELAVAL HOLDING AB, Tumba (SE)

(21) Appl. No.: 12/186,329

(22) Filed: Aug. 5, 2008

Related U.S. Application Data
(60) Provisional application No. 60/954,250, filed on Aug. 6, 2007.

(51) Int. Cl. A23L 3/3508; B01D 15/00

(52) U.S. Cl. 426/335; 422/261

(57) ABSTRACT

A system and method for controlling bacteria in the production of whey protein concentrate (WPC) using an organic oxidizer. In embodiments, peracetic acid is introduced into whey solution before or after it encounters one or more ultrafilters. The peracetic acid, even when used in minute quantities, has proven to have sufficient antimicrobial effect such that bacteria counts in the filter are maintained at acceptable levels. The reduction in bacteria not only helps reduce WPC bacteria counts, but also enables the filters to run longer between cleanings.

### CROSS REFERENCE TO RELATED APPLICATIONS

This application claims the benefit of U.S. Provisional Application No. 60/954,250 filed Aug. 6, 2007, the contents of which are herein incorporated by reference.

### BACKGROUND OF THE INVENTION

1. Field of the Invention

This disclosure relates generally to antimicrobial compositions and processes. More specifically, the invention relates to the use of antimicrobials in the field of dairy production.

2. Description of the Related Art

In dairy processing, one product of the cheese making process is whey. Whey is separated from the curd when producing cheese and casein in conventional processes. Most cheese whey is about 0.5% protein and 5% lactose. Traditionally, the whey was simply disposed of as a byproduct. More specifically, the whey was used as a low-end consumable such as animal feed, fertilizer, or in many cases, simply discarded.

More recently, the whey has been used as a source of protein for human consumption, as well as other higher-end purposes. This has prompted advances in the refinement process. In that vein, once the liquid whey is separated from the curd, it is pasteurized, cooled, and then run through one or more ultrafiltration membranes (a/k/a “ultrafilters”) and/or microfilters. During ultrafiltration, substances with low molecular weight (e.g., water, lactose, and dissolved ions) pass through the membrane in the ultrafilter and higher molecular weight substances (e.g., fat and protein) are retained and a retentate is obtained. The permeate, also referred to as “filtrate,” is substantially free from protein and is useful for known purposes. The retentate, known as Whey Protein Concentrate (WPC), will be extremely protein-rich, and is very useful in producing known protein-based products.

Over time, the ultrafiltration membranes begin to foul with protein and bacteria. As a general principle, numerous kinds of microorganisms tend to foul the filter, disturbing desired flow characteristics. In addition to clogging, however, certain of the microorganisms are potential health concerns. In that vein, the main bacteria of concern are aerobic and anaerobic bacteria. More specifically, the bacteria of most concern are coliform bacteria, which are fermentative, gram negative, and rod-shaped. Because they present health risks, coliform bacteria are subject to stringent governmental regulatory maximums which may not be exceeded. In order to: (i) prevent fouling, and (ii) avoid elevated coliform counts, the filters must be taken off line to be cleaned and sanitized every 20 hours of operation (approximately). During the first few hours the filter is put on line after cleaning, the coliform count will be minimal or zero. But as the filter becomes more fouled over time, the coliform count in the WPC gradually increases to over 200 counts/ml. The Interstate Milk Transportation Service (IMS) requires that all transported milk products should be under 10 counts/ml of coliform so that the microorganisms are not spread from facility to facility. As those skilled in the art are aware, coliforms are also indicative of possible contamination by pathogenic bacteria. Overcoming this dilemma has required either shorter periods of operation between filter cleanings, or further WPC processing, each of which is time consuming and expensive.

### SUMMARY

The disclosed technologies are defined by the claims below. Embodiments of the disclosed technologies, however, include a process comprising providing a source of an acid, where that acid, in one embodiment, is an organic oxidizer, and introducing the acid into a whey solution as part of whey protein concentrate production. In embodiments, peracetic acid is selected as the organic oxidizer which may be used along with other peracids (e.g., octanoic) either alone or in combination.

### BRIEF DESCRIPTION OF THE SEVERAL VIEWS OF THE DRAWINGS

Illustrative embodiments of the disclosed technologies are described in detail below with reference to the attached drawing figures, which are incorporated by reference herein and wherein:

FIG. 1 is a schematic diagram showing one embodiment for a system environment which has been adapted for the purpose of executing the disclosed processes;

FIG. 2 is a chart illustrating PAA dose in ppm versus residual versus coliform count results reached in the execution of embodiments of the disclosed processes; and

FIG. 3 is a chart illustrating PAA dose in ppm versus residual versus coliform count results reached in the execution of embodiments of the disclosed processes.

### DETAILED DESCRIPTION

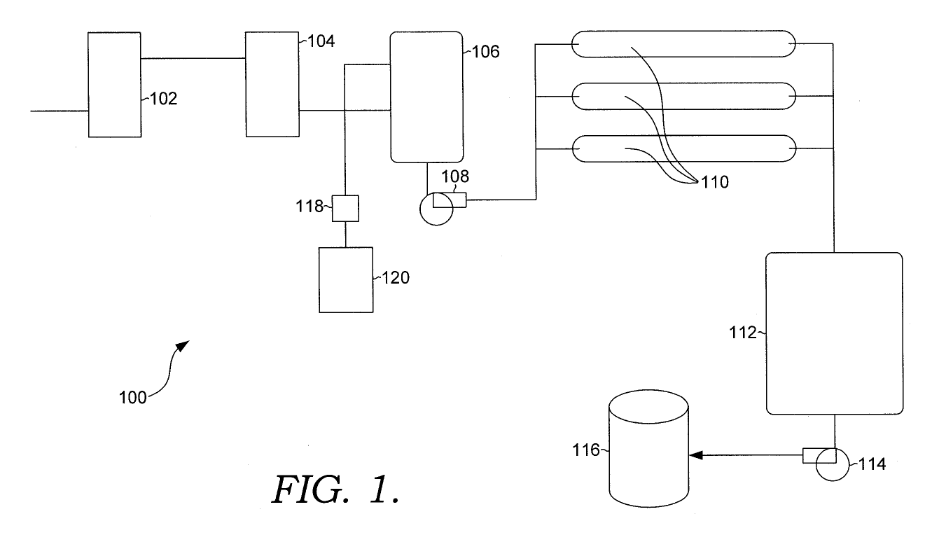

In one embodiment, the disclosed process introduces peracetic acid to control or eliminate microorganisms during whey processing. One embodiment for a system in which these processes may be carried out is shown in FIG. 1. Referring to the figure, a whey processing system 100 is disclosed. System 100 includes a pasteurizer 102 which receives the whey as a by product in a cheese-production facility in a known manner. As is also known, pasteurizer 102 subjects the whey solution to elevated temperatures for sufficient time to effectively kill 99.9% of coliform then existing. Once the whey is pasteurized, it is received into a cooler device 104. Cooler device 104 will be used to bring the whey temperatures to near ambient (approximately 75° F.). Once this occurs, the whey is introduced into a balance tank 106. One skilled in the art will recognize that balance tanks, like tank 106, are often used to receive and temporarily hold the whey prior to filtration. The whey solution is then drawn from balance tank 106 and delivered into one or more ultrafilters 110 (three are shown in the FIG. 1 embodiment) using a pump 108. The one or more ultrafilters 110 are used to continuously separate the protein retentate from the lactose solution permeate. The lactose solution passes through filters 110 and is passed on for further use in a known manner. The protein retentate is then directed into a WPC holding tank 112, where it will ultimately be directed by a pump 114 to a WPC silo 116 for temporary storage.

In one embodiment, an electronic diaphragm pump 118 is used to draw a peracetic acid solution from a container 120 and introduce the solution into balance tank 106. In one embodiment, container 120 is a plastic drum. Containers of other configurations and suitable materials could of course be used instead. One skilled in the art will know that diaphragm pumps like pump 118 are known in the art, are readily commercially available, and have the ability to continually deliver and meter precise quantities of a liquid—in this embodiment—peracetic acid.

Peracetic acid is also readily commercially available. Peracetic acid, also known as peroxyacetic acid, acetic peroxide, acetyl hydroperoxide, and is commercially available in solution with acetic acid and hydrogen peroxide to maintain stability. Further, peracetic acid is marketed under the trade name Proxitane® and others. It is a chemical in the organic peroxide family known to have a strong oxidizing potential, and is represented as chemical formula CH₃CO—OOH. Peracetic acid is produced by reaction of hydrogen peroxide with acetic acid. Various rations of acetic acid to hydrogen peroxide can be used to product peractic acid. The results product will contain an excess of hydrogen peroxide acetic acid or both hydrogen peroxide and acetic acid. Products with either of the material in excess can be employed in this invention.

It is possible that other acids in the organic peroxide family, or other chemical compositions could be used instead of peracetic acid and still amply perform, e.g., blends of peracetic acid and octanoic acid. The peracetic acid may be used along with other peracids, hydrogen peroxide, or other components either alone or in combination. Although peracetic acid has been used in all the examples disclosed herein, its exclusive use should not be considered limiting unless otherwise specified in the claims.

Once pumped into balance tank 106, the peracetic acid is thoroughly blended into the whey solution very quickly. This occurs because the whey solution is dynamically inducted into tank 106, and that creates the turbulence necessary for rapid dilution. Thus, by the time the acid treated whey solution reaches the ultrafilters 110, the acid will have been thoroughly mixed, enabling it to work as an antimicrobial in a uniform manner. It should be noted that the peracetic acid could also be introduced into the whey solution at some other location, or using some other kind of delivery system. Thus, the arrangement used here should not be considered limiting in any fashion unless otherwise specified in the claims. It should be recognized further that the use of the organic oxidizer (e.g., peracetic acid) would alternatively be useful if introduced into the WPC after separation at the filter. This would not reduce the coliform counts at the filter, but would be effective in killing bacteria in the end product. In yet another alternative embodiment, the organic oxidizer could be added at two or more positions both before and after the separation at the filter. Thus, although FIG. 1 shows an introduction point at balance tank 106, the scope of this invention should not be considered limited only to that arrangement.

The amount of peracetic acid introduced into balance tank 106, in the embodiment disclosed in FIG. 1, can be metered using diaphragm pump 118 to result in a desired ppm concentration. It has been determined in lab tests that the demand for peracetic acid (also referred to as “PAA”) in whey is approximately 1 ppm and the demand for peracetic acid in 20% WPC is less than 4 ppm. These peracetic acid demand levels are surprisingly low considering that 175 ppm of chlorine dioxide was required to satisfy oxidative demands, and that peracetic acid has conventionally been considered undesirable in that it is consumed by organics. See, e.g., Kramer, J. F., 1997, Peracetic Acid: A New Biocide for Industrial Water Applications, Paper no. 404, NACE International; Atasi, Rabbaig, Chen, 2001, Alternative Disinfectants Evaluation for Combined Sewage Overflow (CSO). Detroit Baby Creek CSO Case Study, WEFTEC 2001; Colgan, Gehr, 2001, Peracetic Acid Gains Favor as an Effective, Environmentally Benign Disinfection Alternative for Municipal Waste Water Treatment Applications, November 2001, W&ET; Koivunen, Heinonen-Tanski, 2005. Inactivation of Enteric Micro-organisms with Chemical Disinfectants, UV irradiation and Combined Chemical Treatments, Water Research, Volume 39. Thus, the discovery that very low doses of peracetic acid could achieve a sufficient biocidal residual when added to whey and WPC is anomalous.

In trials, a peracetic acid solution was added to the whey at balance tank 106 just in front of the ultrafilters 110 according to the processes discussed above. In terms of finding a desirable concentration level of peracetic acid to create in the balance tank, there are competing interests. Obviously increased PERACETIC ACID levels will improve antimicrobial effect. From economic and regulatory standpoints however, the inclusion of PERACETIC ACID should be minimized. Thus, one objective is to find a level, or range of levels, which will use the minimum amount of acid necessary to effectively bring coliform levels to below 10 counts/ml.

To that end, when peracetic acid was added at 4 ppm, the coliform counts as measured in the retentate (at 21% solids WPC) of the ultrafilter dropped to zero for the entire run time of 20 hours. When the peracetic acid dose was lowered to 3, the coliform counts rose to 10 to 20 counts/ml toward the end of the run as measured in the retentate. These trials revealed that, although any concentration above 5 ppm would have ample antimicrobial effect, the optimal dose based on economics is located between 3 and 5 ppm peracetic acid in the whey solution. For some applications higher doses up to 10 to 20 ppm would be recommended to insure that peracetic acid is dosed high enough to ensure a coliform count less than 10 counts/ml. In certain applications with a relatively low bacterial load levels of 1-2 ppm peracetic acid may be adequate to maintain low coliform count and extended processing times

The effectiveness of the peracetic acid is evident from the test results shown in Table I below. Specifically, the introduction of the preferred ranges of concentrations of peracetic acid results in a reduction in coliform count. Trials 1-13 were conducted on different days in the same facility. The coliform counts taken were measured in the WPC retentate from the ultrafilter. In the disclosed embodiments, the coliform count was taken from the WPC three times during the run. The table includes not only the ppm peracetic acid values dosed into the balance tank based on mass balance calculations, e.g., in tank 106, but also includes ppm values measured in the ultrafilter (UF) permeate. The PAA residual was measured using a modified total chlorine DPD test. DPD testing procedures—commonly used for the purpose of measuring residuals—are well-known colormeric tests which rely on the comparison of a developed color in a water sample against a color standard scale. Those skilled in the art will know how such a test is implemented. Coliforms were measured by plating agar and counting growth cultures after 48 hours. As those skilled in the art will recognize, using plated agar to estimate bacteria counts in liquids is a well known practice which will be familiar to those skilled in the art. Thus, the plate can be used either to estimate the concentration of organisms in a liquid culture or a suitable dilution of that culture, using a colony counter

TABLE I

| | Coliform | | |
|---|---|---|---|
| | Count in | | |
| | 21% | | |
| | solids | ppm PAA | ppm PAA in |
| Trial | WPC | introduced | UF permeate |
| 1 | 250 | 0 | 0 |
| 2 | 50 | 0 | 0 |
| 3 | 50 | 0 | 0 |
| 4 | 80 | 0 | 0 |
| 5 | 120 | 0 | 0 |
| 6 | 30 | 0 | 0 |
| 7 | 0 | 3.5 | 2.5 |
| 8 | 10 | 3.5 | 2.5 |
| 9 | 20 | 3 | 2 |
| 10 | 0 | 3 | 2 |
| 11 | 20 | 3 | 2 |
| 12 | 110 | 0 | 0 |
| 13 | 20 | 3 | 2 |

In a second set of trials, peracetic acid was introduced at levels of, 3, 3.5, 4.0 and 4.5 ppm to show the unexpected effectiveness at these levels. These results are shown in Table II below:

TABLE II

| | Coliform | | |
|---|---|---|---|
| | Count in | | |
| | 21% | | |
| | solids | ppm PAA | ppm PAA in |
| Trial | WPC | introduced | UF permeate |
| 1 | 0 | 4.0 | 3.0 |
| 2 | 0 | 4.5 | 3.5 |
| 3 | 10 | 3.5 | 2.5 |
| 4 | 10 | 3.5 | 2.5 |
| 5 | 20 | 3.0 | 2.5 |
| 6 | 0 | 3.5 | 2.5 |
| 7 | 10 | 3.5 | 2.0 |
| 8 | 0 | 4.0 | 3.0 |
| 9 | 0 | 4.0 | 3.0 |
| 10 | 0 | 4.5 | 3.5 |
| 11 | 0 | 3.5 | 3.0 |
| 12 | 10 | 3.0 | 2.5 |
| 13 | 10 | 3.0 | 2.0 |

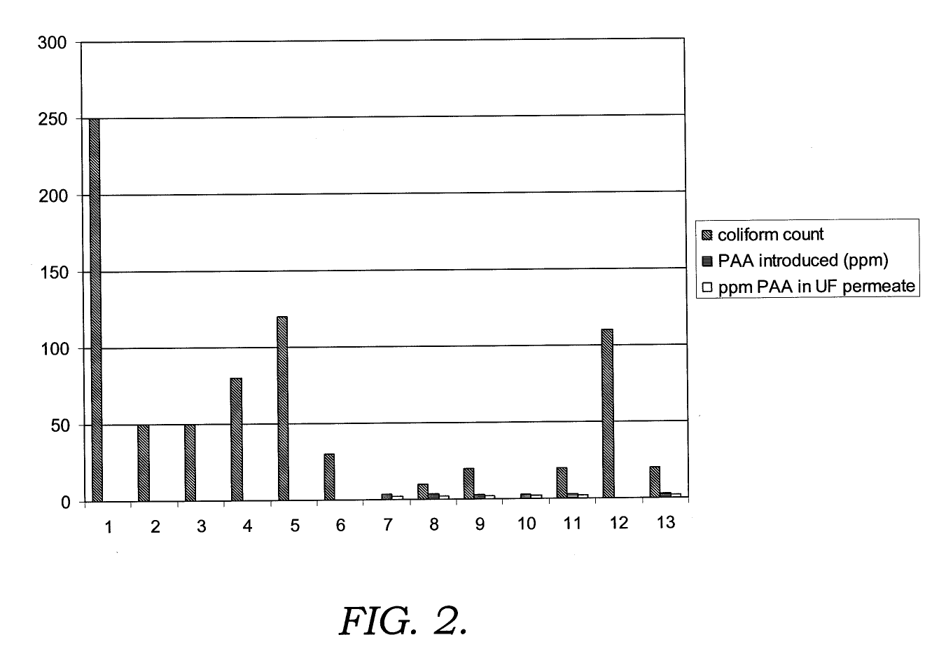

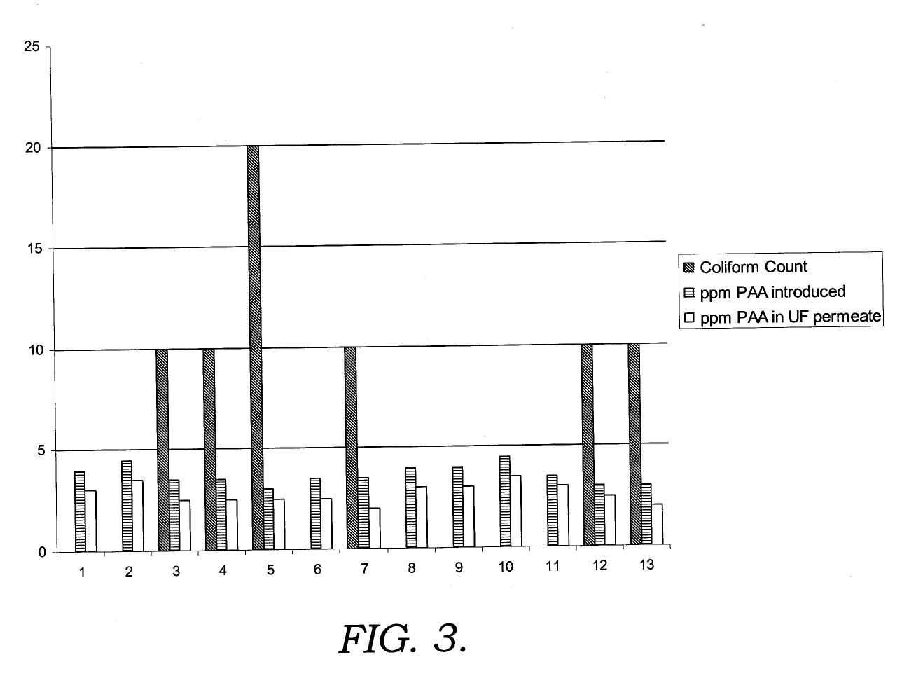

These values have also been plotted out in bar-graph format in FIGS. 2 and 3. It should be noted that, although the example trials above show desirable doses of peracetic acid, other doses would likely also have utility in the field of WPC processing, as well as for numerous other applications, e.g., milk protein concentrate, and milk fat production processes as well as other like endeavors. It should also be recognized that the ideal peracetic acid concentration ranges will depend on the properties of the WPC being processed. For example, the percent solids, processing history, and intended storage time would likely vary the desired amount of peracetic acid to be introduced. Whey quality might also affect desired concentrations. Thus, the trials above should be considered examples only, with the broad aspects of the disclosed processes extending to the use of other peracids in various concentrations.

It is believed that the addition of peracetic acid would have usefulness for numerous applications if introduced in concentrations between 0.0 and 50 ppm. As can be deduced from the above information, the use of peracetic acid in whey is likely to be most useful if introduced at levels between 3 and 5 ppm, approximately. It can also be determined from the above that the most desirable range for introduced peracetic acid would fall between 3.5 and 4.5 ppm, approximately. Further, a minimum level of peracetic acid which may be introduced while maintaining sufficient coliform kill numbers is about 3 ppm. For all of the ranges and other estimations above, it should be understood that optimal peracetic acid concentrations will depend on factors such as the precise composition of the particular whey solution received, the intended storage time anticipated, and the biocidal requirements for the intended use of the WPC (e.g., human consumption versus animal feed). In embodiments where the peracetic acid is introduced into the WPC after separation at the filter, the amount used would depend on the product composition (e.g., % solids).

In addition to showing that the peracetic acid is an effective antimicrobial, Tables I and II above also show that the peracetic acid decomposes moderately. Referring to the tables, it can be seen that the ppm peracetic acid introduced is always about 1 ppm higher than the ppm peracetic acid in the filtered permeate. Thus, peracetic acid decomposition is only about 1 ppm 1 to 5 minutes after addition to whey which is surprisingly low considering conventional thinking regarding the acids consumption into organics. It has further been discovered that the decay rate of the peracetic acid in WPC is fast enough that there is no carry through into any downstream process that could negatively effect the WPC nor would be harmful or violate regulatory standards. For example, whey treated with peracetic acid, produced into WPC, and then stored in tanks with no further processing for 6-10 hours has been found to contain no detectable levels of peracetic acid. This is because the peracetic acid decomposes over time. Thus, the processes above, in addition to being effective in killing bacteria, are also environmentally and consumer friendly.

In addition to fighting harmful coliforms, the peracetic acid also helps maintain filter effectiveness. Not only does the peracetic acid reduce the levels of coliforms in the filter, but actually controls the levels of all bacteria and other microorganisms which collectively will impede flow. Thus, by reducing the overall levels of microorganisms, not just the coliform bacteria, but also numerous other organisms, the membrane fouls slower so that the membrane units are able to run longer. Because of this, the peracetic acid significantly increases the amount of time between filter cleanings without offending industry standards. Because WPC production is able to continuously run without the conventional exponentially increasing bacteria counts, the peracetic acid added saves tremendous time, effort and cost.

It should be noted that, although the embodiments above are associated with WPC processing, there are numerous other uses which would still fall within the scope of the present invention. For example, similar filtration processes are used in the production of Milk Protein Concentrate (MPC) as part of some milk production processes. In MPC production a filtration arrangement is used which is substantially similar to that shown in the WPC system disclosed in FIG. 1. One skilled in the art will recognize that the use of an organic acid, e.g., peracetic acid, could be used in the same ways in these kinds of processes as well and still fall within the scope of the invention here.

Similarly, one skilled in the art will also recognize that the disclosed processes would have alternative usefulness in whey production processes where lactose is retained along with the whey, rather than being separated by the filtration process, thus leaving water as the only permeate. The systems used to execute these alternative whey-processing techniques are known in the field as reverse-osmosis (RO) units. It is contemplated by these disclosures that the organic acid (e.g., peracetic acid) treatment procedures above would be executable in an RO type of arrangement as well as in the WPC systems discussed above.

Many different steps in the various processes, systems, and/or compositions shown, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

The invention claimed is:

1. A process comprising:
providing an acid, said acid comprising an organic oxidizer;
introducing said acid into a whey solution; and
filtering said acid along with said whey solution to produce whey protein concentrate (WPC).

2. The process of claim 1 comprising:
selecting peracetic acid to serve as said organic oxidizer.

3. The process of claim 2 where peracetic acid is added in sufficient quantity to reduce the E. coli concentration below 10 cfu/ml.

4. The process of claim 1 wherein said introducing step further comprises:
delivering said acid into said whey solution in a tank from which said whey solution is pumped in later executing said filtering step.

5. The process of claim 4 wherein said tank is a balance tank.

6. The process of claim 4 wherein said delivering step further comprises:
metering said acid into said tank.

7. The process of claim 6 wherein said metering step further comprises:
maintaining said acid in a drum from which said diaphragm pump is used to deliver said acid.

8. The process of claim 5 wherein said metering step comprises:
mixing said acid into said whey solution at a concentration level of less than 50 ppm.

9. The process of claim 5 wherein said metering step comprises:
mixing said acid into said whey solution at a concentration level of less than 20 ppm in said tank.

10. The process of claim 5 wherein said metering step comprises:
mixing said acid into said whey solution at a concentration level of between about 3 ppm to about 5 ppm in said tank.

11. The process of claim 5 wherein said metering step comprises:
mixing said acid into said whey solution at a concentration level such that a value measured in an ultrafilter (UF) permeate is between about 2 ppm and about 4 ppm.

12. The process of claim 5 wherein said metering step comprises:
mixing said acid into said whey solution at a concentration level such that a value measured in an ultrafilter (UF) permeate is between about 2 ppm and about 3 ppm.

13. The process of claim 1 comprising:
selecting a combination of peracetic acid and an additional per acid to serve as said organic oxidizer.

14. A process comprising:
filtering a whey solution to produce a whey protein concentrate (WPC) product; and
introducing an organic oxidizer into said WPC product for antimicrobial purposes.

15. The process of claim 14 comprising:
selecting peracetic acid to serve as said organic oxidizer.

16. The process of claim 15 comprising:
mixing said acid into said whey solution at a concentration level of less than 10 ppm in said tank.

17. The process of claim 15 comprising:
mixing said acid into said whey solution at a concentration level of between about 3 ppm to about 5 ppm.

18. The process of claim 15 comprising:
mixing said acid into said whey solution at a concentration level such that a value measured in an ultrafilter (UF) permeate is between about 2 ppm and about 4 ppm.

19. The process of claim 15 comprising:
mixing said acid into said whey solution at a concentration level such that a value measured in an ultrafilter (UF) permeate is between about 2 ppm and about 3 ppm.

20. A whey-protein-concentrate production system comprising:
a vessel adapted to receive an organic oxidizer into a whey solution to form a mix, said mix having a concentration of less than 10 ppm organic oxidizer; and
at least one filtration device arranged to receive said mix and produce a whey-protein concentrate product.

21. The system of claim 20 wherein said organic oxidizer includes peracetic acid, and
a subsystem is adapted to deliver said parasetic acid such that a level is between 3 ppm and 5 ppm.

22. A system for controlling the growth of organisms within the filtration membranes of a whey production system, the system comprising:
a tank for temporarily holding a whey solution prior to filtration;
a first delivery mechanism for transferring the whey solution from the tank through at least one filter for separating a protein retentate from a permeate;
a second delivery mechanism for delivering a peracid solution at a predetermined concentration into the tank for mixing with the whey solution prior to the first delivery mechanism transferring the whey from the tank to the at least one filter, the peracid solution effectively retarding the growth of said organisms in said at least one filter.

23. The system of claim 22 wherein said peracid solution includes peracetic acid.
